(19) United States
(12) Patent Application Publication
(10) Pub. No.: US 2012/0078583 A1
(43) Pub. Date: Mar. 29, 2012

(54) System for a structure or a building

(76) Inventor: Frank Kupferle, Vendenheim (FR)

(21) Appl. No.: 12/924,563

(22) Filed: Sep. 29, 2010

(30) Foreign Application Priority Data
Sep. 28, 2010 (FR) 1057838

(51) Int. Cl. G06F 17/50

(52) U.S. Cl. 703/1

(57) ABSTRACT

The present invention is about a design system for the structural design of a structure or building which shall be designed following an applicable standard defining the load combinations and the control values, the said structure or building being constituted of loadbearing members and subject to loads, the load combinations defined in the said applicable standard and applied to the said loadbearing members with the substantially most unfavourable load configuration being intended to induce maximum values of stresses and/or deflections in the said loadbearing members not exceeding the control values defined in the said standard, characterized in that the said design system comprises a database intended to store the numerical values corresponding to parameters related to the act of design, the said parameters taking different numerical values depending on the structure, the building, the materials, the usage, the geographical localisation or the applicable standard.

The present invention concerns a design system for the design of a structure or building which shall be designed following an applicable standard.

Construction of buildings or other structures shall be preceded by a design analysis, in order to verify that the building as it is planned will be sufficiently solid to stay tall, and resist to all forces being applied to it. Such forces are induced by the self-weight of structures, the users of the building through their weight and movement, winds, snow, etc. . . .

These forces are sometimes combined, and it is appropriate to form realistic assumptions to determine to which combinations of forces the structure shall be able to resist. It is for example well known that strong wind will blow the snow away from the roof. It is therefore not necessary to design the structure for a combination of both maximum wind and maximum snow action. It can also be estimated that a structure is not permitted to be accessed by users when wind exceed a certain limit, and therefore prevent too large a cumulation of stresses.

To ensure a satisfactory safety level to the users despite the pressure on costs exercised by the call for tenders which put the builders in competition, standards have been developed by the relevant authorities, which do determine the load combinations to be considered in design, as well as the control parameters to which stresses and deformations obtained with these combinations shall be compared. This point forward, “standard to be used” or “applicable standard” will refer to the group of standards which shall be applied and cover the design of a given building or structure.

So to proceed to such an analysis, it is common to utilise the finite element analysis method or the theory of beams, which form approximations considered as satisfying the exact theoretical analysis. Such an exact analysis is in most of the cases hardly possible to be processed, the number of equation to consider being very large.

Using the aforementioned methods, the analysis focuses first on loadbearing members considered individually, which can be beams (modelled through one dimensional elements, such a one dimensional element being referred to by extension as a beam this point forward) or plates (two dimensional elements), more rarely through 3D elements (three dimensional).

Loads are applied to each of these loadbearing members and the analysis shall determine the value of the maximum stresses and deflections (deformations) induced by the normalised combinations of these loads.

These loadbearing elements are interdependent. They can be supported by or built-in other loadbearing members, or other loadbearing members can be supported by them.

The analysis shall therefore be processed element by element, the result of the analysis on one element serving as an input data for example for the analysis of the loadbearing member by which the first loadbearing member is supported.

Numerous structural analysis programs have been developed taking into account these various parameters. In the likely event of the structure to be designed being relatively complex, such an analysis is long lasting and requires substantial analysis resources.

State of the art programs often present the inconvenience that the load combinations processed following the standards on a loadbearing member are then integrated in the combinations, following the same standards, applied to the loadbearing member by which the first loadbearing member is supported. The consequence is a given over dimensioning of the structure.

Furthermore, state of the art programs are typically developed for a well-defined set of standards, e.g. for the French standards. Other programs are developed for a US standard. With the advent of globalisation, this places such users of these programs in an uncomfortable situation, which are asked to design with other standards than the ones covered by their program. Also, the standards are not set in stone, and e.g. following an incident related to the strength of a structure of building, building authorities seek to improve and adapt the standards, in order to prevent such incidents to occur again. Programs become then obsolete and must be modified to continue meeting the new standards, which represents a significant work item. This induces longer delivery times for the structural design service providers.

There is therefore a need to find a design system, which can avoid the aforementioned drawbacks.

The present invention concerns a design system for the structural design of a structure or building which shall be designed following an applicable standard defining the load combinations and the control values, the said structure or building being constituted of loadbearing members and subject to loads, the load combinations defined in the said applicable standard and applied to the said loadbearing members with the substantially most unfavourable load configuration being intended to induce maximum values of stresses and/or deflections in the said load bearing members not exceeding the control values defined in the said standard.

The system based on the invention is particular in that the said design system comprises at least one database intended to store the numerical values corresponding to parameters related to the act of design, the said parameters taking different numerical values depending on the structure, the building, the materials, the usage, the geographical localisation or the applicable standard.

Hence the design process is facilitated, and it is sufficient to determine which of the parameters shall be considered and the analysis is ready to be started.

Following a preferred embodiment of the invention, the said parameters are the parameters of elaboration of the list of the said load combinations and of all of the said control values.

Such a mode of realisation enables to switch easily from one design standard to another, and to design for example one structure to the French standard, and then another structure to a US standard while using the same program. The design operator will only have to indicate the standard to apply. Moreover, the update of the system to match evolutions of the standards is greatly facilitated.

Following a particularly preferred embodiment of the invention, the said system comprises a finite list of load configurations verifying the property that any configuration susceptible to occur in a structure or building will be sufficiently verified in terms of design if verifications are limited to the load configurations of the said list, and a list of single load cases for each loadbearing member obtained by combining each of the loads applied individually and unfactored to the said loadbearing member with each of the configurations of the said finite list, in which the said parameters are parameters of elaboration of the said list of single load cases.

Hence the program will be able to automatically determine the single load cases that shall be analysed, by searching the necessary parameters in a database.

Following a preferred embodiment of the invention, the said structure or building is substantially in wood, benefiting of all advantages of this type of material.

Following a preferred embodiment of the invention, the said structure or building is substantially in metal, particularly in steel or aluminium, benefiting of all advantages of this type of materials.

Following a preferred embodiment of the invention, the said structure or building is substantially in composite material, benefiting of all advantages of this type of materials.

Following a preferred embodiment of the invention, the said loadbearing members are substantially beam members. The term beam is here to be interpreted as one-dimensional elements. This enables modelling of these members in one single dimension, which allows simpler analysis than with member modelling in two or three dimensions.

Following a preferred embodiment of the invention, the said loadbearing members are substantially plate or shell members. This enables modelling of these members in two dimensions, which allows simpler analysis than with member modelling in three dimensions.

The present invention concerns also a design method for the design of a structure or building which shall be designed following an applicable standard defining the load combinations and the control values, the said structure or building being constituted of loadbearing members subject to loads, the load combinations defined in the said applicable standard and applied to the said loadbearing members with the substantially most unfavourable load configuration being intended to induce maximum values of stresses and/or deflections in the said loadbearing members not exceeding the control values defined in the said standard.

The design method based on the invention is particular in that it comprises at least one of the following stages:
establishment of a list of single load cases to consider for each loadbearing member by means of parameterised formulas in which parameters are replaced by numerical values stored in databases, the said list being defined by application of each of the loads applied to the loadbearing member taken individually and unfactored to a predetermined list of load configurations,
calculation of combinations of stresses and/or deflections resulting from structural design of single load cases, and of control values, by means of parameterised formulas in which parameters are replaced by numerical values stored in databases, the said numerical values varying depending on the applicable standards.

Following an advantageous embodiment of the invention, the said method comprises both of the abovementioned stages, enabling to maximise the advantages provided by the invention.

Finally the present invention concerns the utilisation of a design system based on the invention. The said utilisation is particular in that updates of the system, especially following the modification of a standard or due to the addition of a new material, are overwhelmingly realised exclusively through replacement or addition of a database file, without modification of lines of the programs source code, such that the said updates can be realised using sufficiently small files able to be sent by electronic mail and/or the actual update process by the user can be processed in matter of seconds.

Indeed, with state of the art systems such an update takes usually numerous hours of programming of the source code, which shall then replace the source code previously installed on the users machine. The design system based on the invention is shaped in such a way that such an update is realised by modifying only the content of the databases, without amending the source code itself. It is obvious that modifications of lines of the program might become necessary in exceptional cases such as the significant increase of the number of parameters to be taken into account, or the necessity to take into account a new type of input data, like for example a new data related to sustainable development. This does not detract from the fact that in the vast majority of the updates to be made in the life of such a design system, the update will be realised without modifying the source code itself.

A file for the update of a design system based on the invention will typically have a memory size of about one megabyte, instead of about a five to ten times larger file size if replacement of the source code is required. Now, it is very easy to send a one-megabyte file by electronic mail while it may become problematic with files five to ten times larger.

Also, an update by replacement of a database is a matter of a couple of seconds, e.g. by simply placing the file attached to the electronic mail in the target folder of the design system, while an update by replacement of the source code is usually rather a matter of minutes, often requiring a new installation program.

Other advantages of the invention will appear while reading the description of the following example of realisation and the appended drawings, amongst which:

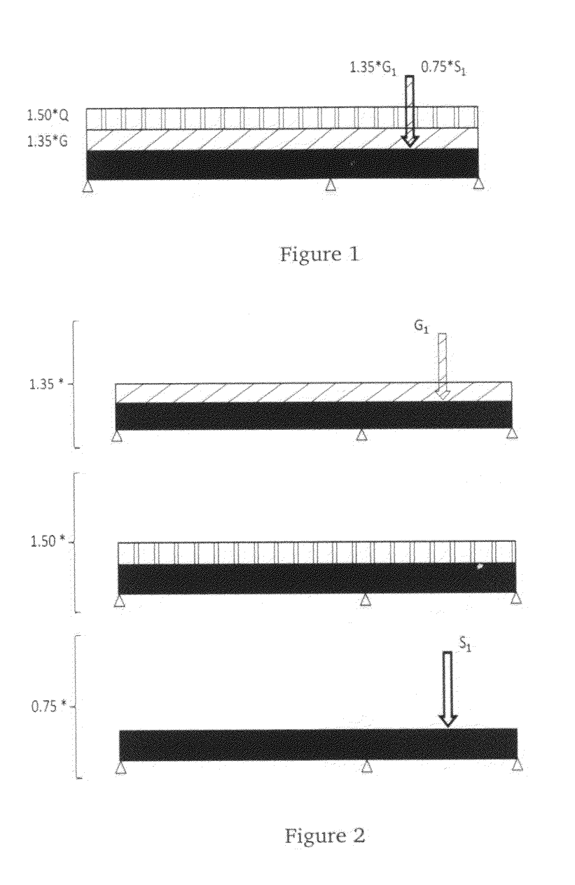

FIG. 1 represents a load case susceptible of being requested to be verified by structural analysis

FIG. 2 represents the decomposition of the load case from FIG. 1 in several single load cases.

We describe thereafter an example of realisation of a design system based on the invention, for the design of a wood structure limited to beams. In the described example the design system uses several databases. The man of the art will be able to understand how to realise design systems using e.g. one single type of database.

The example of design system based on the invention described hereafter uses the principle of superposition coupled to the decomposition of all of the factors influencing the design of a beam per numerous different design standards, programmed dynamically and driven by the content of databases screened blind, without the design operator intervening.

In order to ensure proper understanding of the terms that will be used repeatedly, some expressions are defined hereafter:
Load combination=situation in which several different types of loads (dead load, live load, snow, . . . ) are considered simultaneously, possibly factored using combination factors when required by the applicable standard.
Load configuration=situation in which variable loads are applied on some portions (typically a portion is a span) of a loadbearing member and not on others (the application on all portions is considered a configuration also); dead load is always applied to all spans.
Load case=a given combination considered with a given configuration.

The design is performed in 3 steps:
It starts with a decomposition of the load cases in single load cases which will be referred to thereafter as SLC (for Single Load Case). The goal is on one hand to define a finite list of load configurations ensuring that any configuration occurring in a structure or building will be sufficiently verified in terms of structural design if one limits the design to only the configurations of that list, on the other hand to apply only one load type to each SLC, unfactored. The way of elaborating this list will be described more precisely thereafter.
Next, each of these SLCs is sent to the solver independently from the load combinations required by the applicable standard. All of the SLCs together shall enable by combination to obtain all of the load cases required by the applicable design standard.
Finally, following the requirements of the design standard used, the calculation results of these SLCs are combined.

The design system based on the invention provides significant advantages not only in terms of calculation time, but mostly in terms of precision of the design results, which in turn induces a gain in the amount of material used in a structure or building. These advantages are described more precisely further in this document. It enables also to implement a dynamic management of the load combinations and load configurations driven by an ad hoc database and not predetermined or “hardcoded” in the programming code, highly improving the flexibility for implementation of modifications (when standards are modified) or integration of new standards (new markets or countries). This induces a significant gain in the delivery time for the design, and enables the builder to take buying or transportation opportunities enabling in fine to build a better optimised structure or building in terms of choice of materials, type of structure and weight of the structure.

The design system based on the invention is founded on a decomposition of all of the factors influencing the structural design of a beam per numerous different design standards, programmed dynamically. Hardly any factor or coefficient is hardcoded, the vast majority of them being read from a specific database. This enables to auto-determine the required combinations, configurations, factors and verifications to be performed, by screening of databases, and creates a large flexibility enabling to add new design standards or modify design standards already covered by the design module in very limited time. It becomes therefore possible to update such a system online, as it does not require modifying the executable file, but only the relevant databases.

For illustrating purposes, we describe thereafter the principle of factoring and combination of loads per Eurocode 5, in verification of Ultimate Limit States, further referred to as ULS, using the so called characteristic load combination as follows:

qₜₒₜ=1.35*G+1.50*A₁+Σ(1.50*ψ_{0,i}*Aᵢ)

where:
qₜₒₜ is the total load acting on the member for the considered load case
G is the dead load
A₁ is the leading variable action
Aᵢ are the companion variable actions
ψ_{0,i} is the partial coefficient fir combination of loads—variable for each type of load and different from 1.0:
   e.g. 0.70 for Q, 0.50 for S, 0.60 for W, where
Q is the imposed (live) load
S is the snow load
W is the wind load

When considering a combination of all of these load types and the three permutations to be verified per Eurocode, different load factors are obtained for each different load type:

q_{tot,1}=1.35*G+1.50*Q+1.50*0.50*S+1.50*0.60*W=1.35*G+1.50*Q+0.75*S+0.90*W
which is the example used in the majority of the descriptions thereafter

q_{tot,2}=1.35*G+1.50*S+1.50*0.70*Q+1.50*0.60*W=1.35*G+1.50*S+1.05*Q+0.90*W

q_{tot,3}=1.35*G+1.50*W+1.50*0.50*S+1.50*0.70*Q=1.35*G+1.50*W+0.75*S+1.05*Q

The principle of superposition enables to decompose any complex solicitation in a sum of elementary solicitations which effects are finally added together. This is illustrated in the conceptual diagrams of FIGS. 1 and 2.

The result of the structural analysis of the beam in the load case of FIG. 1 is identical with the factored sum of the three SLCs of FIG. 2.

The load combinations required for the structural analysis of a member are defined in the applicable standards. The list of required combinations is therefore frequently different from one standard to another or from one country to another. Similarly, depending on the design standards, the load factors or load combination coefficients can be different.

Also, for a given load combination, different load configurations shall be verified separately in order to determine the most unfavourable configuration of variable (non permanent) loads following the principle of free moving loads. These configurations are dependent from the span and bearing configuration of the beam being designed: the greater the number of spans and bearings, the greater the number of different possible configurations. It shall be noted that a cantilever (overhang) is typically considered a span when determining the possible configurations, despite the absence of end bearing.

Hence, the number of load cases is grossly equal to the number of combinations multiplied by the number of configurations.

Most of the design standards do not expressively stipulate which configurations shall be verified, but do set the principle of mobility of the variable loads and of verification of the most unfavourable case. It is therefore the designer's responsibility to determine which configurations shall be analysed. Using the principles of material resistance design, of the theory of beams and a certain experience of design, the man of the art can easily define a finite number of configurations which will enable to design a beam with an acceptable error margin while considering the most unfavourable case. These configurations typically consist in defining for each span whether the relevant variable load will be applied to it totally, partially or not at all.

The design system based on the invention is based on a finite predetermined number of elementary load configurations, which can be applied to each of the variable loads present on the beam member being considered.

Table No 1 shows an example of a finite and predetermined list of load configurations (along with their definition), which will be utilised further in the description of the invention.

From this point forward of the description of the invention, the 7 configurations identified 0 to 6 will be considered as the finite list of elementary configurations. The invention of course also covers design systems for which one would define less than 7 elementary configurations, or more than 7, or with more spans, or with subdivisions of spans, provided a finite number of configurations is defined.

TABLE NO 1
list of load configurations

| ID | Description | Span 1 | Span 2 | Span 3 | Span 4 |
|---|---|---|---|---|---|
| 0 | Loading on all spans | XXXXXXX | XXXXXXX | XXXXXXX | XXXXXXX |
| 1 | Loading on EVEN spans only | | XXXXXXX | | XXXXXXX |
| 2 | Loading on ODD spans only | XXXXXXX | | XXXXXXX | |
| 3 | ADJACENT spans loading 1 (1 + 2) | XXXXXXX | XXXXXXX | | |
| 4 | ADJACENT spans loading 1 (2 + 3) | | XXXXXXX | XXXXXXX | |
| 5 | ADJACENT spans loading 1 (3 + 4) | | | XXXXXXX | XXXXXXX |
| 6 | ADJACENT spans loading 1 (1 + 4) | XXXXXXX | | | XXXXXXX |

Each of the elementary configurations is accompanied by an identification parameter and a certain number of attributes allowing determining whether to consider it or not depending on the spans and bearings information of the beam member being designed. The following shall be defined a minima:
ModelNb=an unique identifier of the load configuration which is independent from the type of load being considered
MinNbSpan=the minimum number of spans required for the load configuration to be applicable (e.g. a configuration considering loading of even spans only would not apply if the beam would have only one span)

A quick analysis of the table above shows that:
When only one span is present:
   configuration 0 is sufficient,
   configurations 2, 3 and 6 are redundant with configuration 0
   configurations 1, 4 and 5 are not applicable
When two spans are present:
   configurations 0, 1 and 2 are sufficient,
   configurations 3, 4 and 6 are redundant with configurations 0, 1 and 2
   configuration 5 is not applicable
When three or more spans are present:
   All configurations 0 to 6 shall be considered

Hence the values of the MinNbSpan attribute can be deducted for each of the 7 configurations:
Configuration 0 MinNbSpan=1 this configuration shall always be considered
Configuration 1 & 2 MinNbSpan=2 these configurations shall be considered for 2 or more spans
Configuration 3 & 6 MinNbSpan=3 these configurations shall be considered for 3 or more spans

The design system based on the invention is also based on a finite number of load types to be considered which can vary from one country to another and from one standard to another.

From this point forward of the description of the invention, the loads G, Q, S and W as defined on page 6 will form the finite list of loads to be considered.

The design system based on the invention utilises a finite number of SLCs, which enable the decomposition of load cases required by the relevant design standard following the principle of superposition.

The SLCs are determined by combining the types of loads with the elementary load configurations:
G configuration 0 (dead load is always present on all spans and is not mobile)
Q configurations 0 to 6
S configurations 0 to 6
W configurations 0 to 6

This represents a total of 22 different SLCs, which each induce calling the solver when they are effectively considered in the design process.

The design system based on the invention enables the auto-determination of the SLCs to consider for a given beam member with the loads being applied to it, by means of an automated procedure which obtains from the reading of the SLC database the list of SLCs to consider actually in the analysis.

It is sought to prevent considering SLCs which do not apply to a given design process. For example, when a beam member is only subject to load types G and Q, one would not want to consider the solver for the 14 SLCs that consider only the load types S and W.

In order to achieve this, beyond a unique identifier, each SLC is being attributed a binary (0 or 1) value depending on how critical each load type is to consider this SLC:
CriticalG=1 if presence of load type G is critical for considering the SLC; 0 else
CriticalQ=1 if presence of load type Q is critical for considering the SLC; 0 else
CriticalS=1 if presence of load type S is critical for considering the SLC; 0 else
CriticalW=1 if presence of load type W is critical for considering the SLC; 0 else

A binary boolean (0 if false; 1 if true) is utilised for each load type stipulating the presence of a non null load of that type on the considered beam member:
IsG=1 if a non-null load of type G is present on the beam; 0 else
IsQ=1 if a non-null load of type Q is present on the beam; 0 else
IsS=1 if a non-null load of type S is present on the beam; 0 else
IsW=1 if a non-null load of type W is present on the beam; 0 else

The effective number of spans is compared to the condition on the minimum number of spans MinNbSpan in order to determine the value of a binary boolean ConsiderSpan taken as 1 if the effective number of spans is greater than MinNbSpan, taken as 0 else.

Both sets of data are combined together, and further combined to the condition of the minimum number of spans ConsiderSpan in order to determine the value of a binary boolean ConsiderSLC, which result states whether a given SLC shall be considered or not:

ConsiderSLC=ConsiderSpan*(CriticalG*IsG+CriticalQ*IsQ+CriticalS*IsS+CriticalW*IsW)

The SLC is considered in the design process when ConsiderSLC is non-null, the SLC is ignored when ConsiderSLC is null.

The advantage at this stage of the design system based on the invention is the obvious simplicity of the programming procedure for modifications and the flexibility for adding or modifying an SLC, a load type, a load configuration, without the need to enter in complex imbrications of conditional loops (if/then/else alike), enabling amongst other to proceed to such changes remotely, for example via an internet connection.

The entirety of the data necessary for the auto-determination of the SLCs to be analysed can be gathered in the same database following the format of table No 2 (reproducing the data of the previously described example)

TABLE No 2
Database of SLC attributes

| No | SLCID | Load | ModelNb | SLCDescription | MinNbSpan | CriticalG | CriticalQ | CriticalS | CriticalW |
|---|---|---|---|---|---|---|---|---|---|
| 1 | G-0 | G | 0 | ALL Spans | 1 | 1 | 0 | 0 | 0 |
| 2 | Q-0 | Q | 0 | ALL Spans | 1 | 0 | 1 | 0 | 0 |
| 3 | Q-1 | Q | 1 | Alternate ODD | 2 | 0 | 1 | 0 | 0 |
| 4 | Q-2 | Q | 2 | Alternate EVEN | 2 | 0 | 1 | 0 | 0 |
| 5 | Q-3 | Q | 3 | Adjacent 1 | 3 | 0 | 1 | 0 | 0 |
| 6 | Q-4 | Q | 4 | Adjacent 2 | 3 | 0 | 1 | 0 | 0 |
| 7 | Q-5 | Q | 5 | Adjacent 3 | 3 | 0 | 1 | 0 | 0 |
| 8 | Q-6 | Q | 6 | Adjacent 4 | 3 | 0 | 1 | 0 | 0 |
| 9 | S-0 | S | 0 | ALL Spans | 1 | 0 | 0 | 1 | 0 |
| 10 | S-1 | S | 1 | Alternate ODD | 2 | 0 | 0 | 1 | 0 |
| 11 | S-2 | S | 2 | Alternate EVEN | 2 | 0 | 0 | 1 | 0 |
| 12 | S-3 | S | 3 | Adjacent 1 | 3 | 0 | 0 | 1 | 0 |
| 13 | S-4 | S | 4 | Adjacent 2 | 3 | 0 | 0 | 1 | 0 |
| 14 | S-5 | S | 5 | Adjacent 3 | 3 | 0 | 0 | 1 | 0 |
| 15 | S-6 | S | 6 | Adjacent 4 | 3 | 0 | 0 | 1 | 0 |
| 16 | W-0 | W | 0 | ALL Spans | 1 | 0 | 0 | 0 | 1 |
| 17 | W-1 | W | 1 | Alternate ODD | 2 | 0 | 0 | 0 | 1 |
| 18 | W-2 | W | 2 | Alternate EVEN | 2 | 0 | 0 | 0 | 1 |
| 19 | W-3 | W | 3 | Adjacent 1 | 3 | 0 | 0 | 0 | 1 |
| 20 | W-4 | W | 4 | Adjacent 2 | 3 | 0 | 0 | 0 | 1 |
| 21 | W-5 | W | 5 | Adjacent 3 | 3 | 0 | 0 | 0 | 1 |
| 22 | W-6 | W | 6 | Adjacent 4 | 3 | 0 | 0 | 0 | 1 |

Here also, the number of SLCs or of their attributes is only limited for the purpose of the example, and many more can be defined, depending on the load types being handled, which can be and often are more numerous than the four types considered in this example.

Each required SLC is then utilised to define the model of the loads being applied to the beam member being designed.

The design system based on the invention comprises a temporary storage table of the SLC analysis results in a consistent format whatever the SLC, so to be able to combine and factor a posterior these results.

In a matrix solver, the beam member that will be analysed shall be modelled in form of nodes joined together by contiguous bars, each of the nodes being attributed a given number of degrees of freedom. Each bar is then subdivided in a predetermined number of segments so to be able to refine the analysis results within the bar.

The geometrical modelling of the beam (nodes and bars) is identical for all of the SLCs and follows rules independent from these. The consistency of the geometrical modelling throughout is crucial so to enable creating a temporary storage table of the analysis results of required SLCs, which can be called later when combining and factoring these results.

Typically, the analysis results returned by the matrix solver are:
R=the reactions at bearings
M=the bending moment at both ends of each segment
D=the bending deflection at both ends of each segment
V=the vertical shear at both ends of each segment

In the simple case of a beam with two end bearings, modelled by one single bar between two nodes, each bar being subdivided e.g. in 10 segments, one gets:
R=2 values for each SLC
M=11 values for each SLC (10 segments/intervals, hence 10+1 ends)
D=11 values for each SLC
V=11 values for each SLC

The table of the SLC analysis results for this simple example are presented in table No 3 (values are given in form of indexes).

A consistent table of values is thus available, which can be called by a common procedure when it comes to factor and combine the results of the SLC corresponding to each of the load cases required by the applicable standard.

The design system based on the invention enables to factor and combine loads following the requirements of any design standard, although each of them requires potentially different combinations, but also and more importantly different load combination coefficients and load magnitude factors. This flexibility is given by the design system based on the invention by the joined utilisation of two key elements:
A generic equation for combining and factoring loads which is applicable to all standards
A database which format is consistent with the generic equation and which contains all of the load magnitude factors and load combination coefficients for each of the load type and each of the design standards
As the load combinations (referred to as CLC for Combined Load Case) are applicable to the verifications of acting stresses and resistances (ULS) as well as to the verifications of deflections (Serviceability Limit States, referred to as SLS thereafter), these two families shall be considered separately, recognising that the load magnitude factoring (when required by a design standard) does apply to resistances but never applies to deflections. Moreover, for some building materials like e.g. wood, creep factors (increasing the instantaneous deflection calculated by the solver in application of the rules of the theory of beams) shall be applied to deflections (SLS), which do not apply to acting stresses and resistances (ULS).

TABLE No 3
Storage table of SLC analysis results

| SLC | SLC | | Model | | | | | | | | | | | | |
|---|---|---|---|---|---|---|---|---|---|---|---|---|---|---|---|
| No | ID | Load | Nb | Reactions | | Moment | | | Deflections | | | Shear | | | . . . |
| 1 | G-0 | G | 0 | R_{1,1} | R_{2,1} | M_{1,1} | M_{1,1} | M_{11,1} | D_{1,1} | D_{1,1} | D_{11,1} | V_{1,1} | V_{1,1} | V_{11,1} | . . . |
| 2 | Q-0 | Q | 0 | R_{1,2} | R_{2,2} | M_{1,2} | M_{1,2} | M_{11,2} | D_{1,2} | D_{1,2} | D_{11,2} | V_{1,2} | V_{1,2} | V_{11,2} | . . . |
| 3 | Q-1 | Q | 1 | R_{1,3} | R_{2,3} | M_{1,3} | M_{1,3} | M_{11,3} | D_{1,3} | D_{1,3} | D_{11,3} | V_{1,3} | V_{1,3} | V_{11,3} | . . . |
| 4 | Q-2 | Q | 2 | . . . | . . . | . . . | . . . | . . . | . . . | . . . | . . . | . . . | . . . | . . . | . . . |
| 5 | Q-3 | Q | 3 | . . . | . . . | . . . | . . . | . . . | . . . | . . . | . . . | . . . | . . . | . . . | . . . |
| 6 | Q-4 | Q | 4 | . . . | . . . | . . . | . . . | . . . | . . . | . . . | . . . | . . . | . . . | . . . | . . . |
| 7 | Q-5 | Q | 5 | . . . | . . . | . . . | . . . | . . . | . . . | . . . | . . . | . . . | . . . | . . . | . . . |
| 8 | Q-6 | Q | 6 | . . . | . . . | . . . | . . . | . . . | . . . | . . . | . . . | . . . | . . . | . . . | . . . |
| . . . | . . . | . . . | . . . | . . . | . . . | . . . | . . . | . . . | . . . | . . . | . . . | . . . | . . . | . . . | . . . |
| N | X-0 | X | 0 | R_{1,N} | R_{2,N} | M_{1,N} | M_{1,N} | M_{11,N} | D_{1,N} | D_{1,N} | D_{11,N} | V_{1,N} | V_{1,N} | V_{11, N} | . . . |
| N + 1 | X-1 | X | 1 | . . . | . . . | . . . | . . . | . . . | . . . | . . . | . . . | . . . | . . . | . . . | . . . |
| N + 2 | X-2 | X | 2 | R_{1,N+2} | R_{2,N+2} | M_{1,N+2} | M_{1,N+2} | M_{11,N+2} | D_{1,N+2} | D_{1,N+2} | D_{11,N+2} | V_{1,N+2} | V_{1,N+2} | V_{11,N+2} | . . . |
| N + 3 | X-3 | X | 3 | . . . | . . . | . . . | . . . | . . . | . . . | . . . | . . . | . . . | . . . | . . . | . . . |
| N + 4 | X-4 | X | 4 | . . . | . . . | . . . | . . . | . . . | . . . | . . . | . . . | . . . | . . . | . . . | . . . |
| N + 5 | X-5 | X | 5 | . . . | . . . | . . . | . . . | . . . | . . . | . . . | . . . | . . . | . . . | . . . | . . . |
| N + 6 | X-6 | X | 6 | . . . | . . . | . . . | . . . | . . . | . . . | . . . | . . . | . . . | . . . | . . . | . . . |
| . . . | . . . | . . . | . . . | . . . | . . . | . . . | . . . | . . . | . . . | . . . | . . . | . . . | . . . | . . . | . . . |

The design system based on the invention comprises therefore two generic equations for combining and factoring the loads, one for ULS, the other for SLS, both calling factors contained in the CLC database (database of combinations) which are applied to the load combination coefficient and load magnitude factors, these being contained in another database, however without any of these factors or coefficients being hardcoded in the source code.

To achieve this, the design system based on the invention innovatively utilises the factors read from the CLC database as multiplier as well as exponent of the coefficient or factor or load being called.

The following is distinguished:
Consider[load]Factor the factor enabling to consider or not the load in the combination
K_[load] a load magnitude factor of the load type [load]
C_[load] a load combination coefficient of the load type [load]
K_[load]Factor the factor to the load magnitude factor K_[load]
C_[load]Factor the factor to the load combination coefficient C_[load]
ULS_[load] the global factor being finally applied to the load type [load] for ULS

When considering ULS, a further differentiation can be made between permanent loads (or dead load), here noted G, and variables loads or actions, as for obvious reasons related to the essence of these loads being always present, the consideration of permanent loads is subject to less possible variations than other load types, and this in all design standards.

The ULS generic equation for permanent loads G can therefore be written by means of 3 factors:
K_G load magnitude factor ≧1 when G acts unfavourably
K_GUp load magnitude factor ≦1 when G acts favourably (e.g. uplift)
K_GAdj additional adjustment factor which is required for some design standards
   which must be combined to the factors applying to each of them:
K_GFactor exponent applicable to K_G
K_GUpFactor exponent applicable to K_GUp
K_GAdjFactor exponent applicable to K_GAdj

This data is then combined to obtain the global factor applicable to the permanent load G:

ULS_{—}G=K_{—}GAdĵK_{—}GAdjFactor*K_{—}ĜK_{—}GFactor*K_{—}GUp̂K_{—}GUpFactor

Note: As the load type G is always applicable to ULS, there is no factor for considering the load ConsiderGFactor, as well as no load combination coefficient.

The strong variations of the different design standards in combining and factoring variables loads, which for the same given type of load can require different load magnitude factors and/or load combination factors depending on whether this load is combined with that or the other type of load, make it necessary to utilise 3 load magnitude factors and 3 load combination coefficients for each load type.

The generic ULS equation for the variable load type, which is the equation applicable to all variable load types, can therefore be written by means of 6 factors:
K_[load]1, 2, 3 load magnitude factors No 1, 2, 3
C_[load]1, 2, 3 load combination coefficients No 1, 2, 3
   which must be combined to the factors applying to each of them:
K_[load]1Factor, 2Factor, 3Factor exponents applicable to K_[load]1, 2, 3
C_[load]1Factor, 2Factor, 3Factor exponents applicable to C_[load]1, 2, 3

Finally, the factor for consideration of the load type for the given load combination is utilised: Consider[load]Factor

This data is then combined to obtain the global factor applicable to the variable load:

ULS_[load]=Consider[load]Factor*Πₙ₌₁₋ₙ{C_[load]n̂C_[load]nFactor*K_[load]n̂K_[load]nFactor}

The generic equation for the load combination [CLC] is therefore:

ULS_[CLC]=ULS_{—}G*G+Σ₍ᵢ₌₁₋ⱼ₎{ULS_[loadi]*[loadi]}

for the j variable loads [load i] present on the beam member being designed.

When considering SLS, permanent loads (or dead load) can also be differentiated from variable loads or actions.

Moreover, unlike for ULS, loads cannot simply be factored and combined: the calculation of the total deflection must be performed directly from the instantaneous deflections calculated by the solver (see section 3). The following is therefore defined:
Uinst_[load] instantaneous deflection due to the load type
Ufin_[load] final deflection due to the load type [load]
Utot_[CLC] total final deflection of the load combination [CLC]

Complementary factors and coefficients are necessary also:
C_Creep the creep factor C_Creep of the material
InstantFactor_[load] a factor (0 or 1) applied to the instantaneous deflection due to the load
CreepConsider_[load] a factor enable to consider or not the effect of creep due to the load
CreepFactor_[load] a factor applied to the creep factor C_Creep or the material
This data is then combined to obtain the final deflection due to the permanent load G:

Ufin_{—}G=Uinst_{—}G*(InstantFactor_{—}G+CreepFactor_{—}G*C_Creep)

The strong variations of the different design standards in combining variables loads, which for the same given type of load can require different load combination factors depending on whether this load is combined with that or the other type of load, make it necessary to utilise 3 load combination coefficients for each load type.

The generic SLS equation for the variable load type (equation which is applicable to all variable load types) can therefore be written by means of the factors C_Creep, C_[load]1, 2 and 3, which shall be combined with Consider[load]Factor, CreepConsider_[load], CreepFactor_[load]3, as well as with the following factors:
InstantFactor_[load]1 a factor (0 or 1) applied to the load combination coefficient No 1
InstantFactor_[load]2 a factor (0 or 1) applied to the load combination coefficient No 2
InstantFactor_[load]3 a factor (0 or 1) applied to the load combination coefficient No 3

This data is then combined to obtain the final deflection due to the variable load [load]:

Ufin_[load]=Uinst_[load]*(Consider[load]Factor+Σ₍ₙ₌₁₋ₙ₎{InstantFactor_[load]n*C_[load]n}+CreepConsider_[load]*C_[load]3̂CreepFactor_[load]3*C_Creep)

The generic equation for the load combination [CLC] is therefore:

Utot_[CLC]=Ufin_{—}G+Σ₍ᵢ₌₁₋ᵢ₎{Ufin_[loadi]}

for the j variable loads [load i] present on the beam member being designed.

Wood as a structural material adds an additional difficulty related to the fact that its resistance is dependent from both its moisture content (further noted MC) and the duration of loading (DOL: duration of load): the resistance can easily be halved when the duration of loading and/or the MC increase, namely when the solicitation changes from quasi instantaneous (minutes) to permanent (dead load).

The different types of load are considered of different and variable duration. The design standards which do consider this specificity (not all standards do) also define DOL classes, which can differ significantly by their number as well as by the intensity of modification of the wood resistances they induce.

Moreover, from one design standard to another a given type of load can be classified differently in terms of DOL.

It appears obvious that only one DOL class can be applied at a time, hence for a given combination of loads. All of the design standards considering DOL have covered this fact by setting the principle that the DOL class of a load combination is taken as the shortest of the DOL classes from the different loads present in that combination. For example:
when combining G (permanent), Q (medium term) and S (short term), the combination will be classified “short term”
when adding W (instantaneous), the combination then becomes classified “instantaneous”
if considering G and Q only, it would be classified <<medium term>>

However, this specificity adds significant complexity to programming of the design as soon as several design standards are expected to be handled within the same design module.

The design system based on the invention requires the definition of a predetermined and finite number of “system” (i.e. independent from the design standard) DOL classes, each being assigned a unique identification number, as well as a database containing the assignment of the DOL classes of each design standard to one of the “system” DOL classes.

The “system” numbering increases inversely from the increase of load duration.

For each of the design standards, the DOL classes are listed in a specific database, and assigned in the same order of decreasing load duration to the corresponding “system” DOL class.

This allows to determine easily and independently from the design standard used the DOL class assigned to a given load combination by determining the largest value amongst the identification numbers of the “system” DOL classes of the loads present in that combination.

The design system based on the invention also comprises a database in which for each design standard the different load types are assigned a “system” DOL class (it shall be reminded that this methodology requires a predetermined and finite number of load types, which continues to make sense here).

It is frequent that the duration of load varies even for the same type of load depending on the destination or category of use of the building. This is for example the case for live loads which can differ by their magnitude as well as by their duration of load depending on whether the building is designed for residential, office, storage, etc. . . . purposes, or for snow loads depending on whether e.g. the building is located at an altitude greater or smaller than 1000 m a.s.l.

The design system based on the invention requires therefore a predetermined and finite number of categories of use or snow zones which, combined with the different types of load, enable to define a finite number of configurations which can be independently assigned a DOL class.

Table No 4 thereafter shows an example of database defining the DOL classes for some of the design standards:

TABLE NO 4
DOL classes

| “System” | | CB 71 | BS 5268-2 | IBC 2009 | NBCC 2005 |
|---|---|---|---|---|---|
| DOL Class | Eurocode 5 | France | UK | USA | Canada |
| 1 | Permanent | 1st type | Long Term | 90% DOL | Permanent |
| 2 | Long Term | 2nd type | Medium Term | 100% DOL | Standard Term |
| 3 | Medium Term | — | Short Term | 115% DOL | Short Term |
| 4 | Short Term | — | Very Short Term | 125% DOL | — |
| 5 | Instantaneous | — | — | 160% DOL | — |
| . . . | — | — | — | — | — |

Table No 5 shows an example of database assigning the load types to “system” DOL classes, and shows the disparity of classifications from one standard and/or country to another:

TABLE No 5
Load type assignment to DOL classes

| Standard | | | | | | | | | | | |
|---|---|---|---|---|---|---|---|---|---|---|---|
| ID | Standard | Country | DOL_G | DOL_QA | DOL_QB | DOL_QC | DOL_QD | DOL_QE | DOL_S1 | DOL_S2 | DOL_W |
| 1 | Eurocode 5 | France | 1 | 3 | 3 | 3 | 3 | 2 | 4 | 3 | 4 |
| 2 | Eurocode 5 | UK | 1 | 3 | 3 | 3 | 3 | 2 | 4 | 4 | 5 |
| 3 | IBC 2009 | USA | 1 | 2 | 2 | 2 | 2 | 2 | 3 | 4 | 5 |
| 4 | NBCC 2005 | Canada | 1 | 2 | 2 | 2 | 2 | 2 | 2 | 2 | 3 |
| 5 | BS 5268-2 | UK | 1 | 1 | 1 | 1 | 1 | 1 | 2 | 2 | 3 |
| 6 | CB 71 | France | 1 | 1 | 1 | 1 | 1 | 1 | 1 | 1 | 1 |
| . . . | . . . | . . . | . . . | . . . | . . . | . . . | . . . | . . . | . . . | . . . | . . . |

Note:
In this example the categories of use of the building are numbered A, B, C, D and E and appear as a suffix to DOL_Q. Similarly both altitude zones 1 and 2 for snow appear as a suffix to DOL_S.

As for the SLCs, the design system based on the invention enables the auto-determination of the combined load cases (CLC) and of the elementary configurations of load to be considered for a given beam member with the loads applied to it, by means of an automated procedure which obtains from the reading of the CLC database the list of CLCs to consider actually in the analysis. Each combination of loads required by the design standard is treated twice:
once for the ULS for each of the elementary configurations of load
once for the SLS for each of the elementary configurations of load

For example, when combining G, Q and S, knowing that Q and S shall be evaluated following the 7 elementary configurations of load, the load combination G+Q+S is repeated 7 times, considering in turn each of the elementary configurations applied to Q and S (G being always present on all spans).

This forms 7 CLCs, which can be used for verification of the ULS by utilising the corresponding generic equation.

These 7 CLCs are then duplicated for assignment to calculation of deflections by utilising the SLS generic equation.

Each of the CLC is therefore assigned an identification parameter and a given number of attributes enabling to consider it or not, depending on the spans and bearings information of the beam member being designed. The following shall be defined a minima:
Norm_ID=a unique identifier of the design standard considered
CLC_ID=an unique identifier of the CLC within the scope of the design standard being considered
MinNbSpan=the minimum number of spans required for the CLC to apply

Each CLC is assigned a unique Identifier within the scope of a given design standard. Utilising the unique identifier of the standard enabling to select the section of the database corresponding with the selected standard, a given CLC number can be used several times while still identifying absolutely uniquely a given CLC of a given standard by combined query utilising both identifiers.

Similar to the SLCs, it is sought to prevent considering CLCs which do not apply to a given design process. In order to achieve this, beyond a unique identifier, each CLC is being attributed a binary (0 or 1) value depending on how critical each load type is to consider this CLC, as well as a binary boolean (0 if false; 1 if true) for each load type stipulating the presence on a non null load of that type on the beam member being designed.

Finally, it shall be possible to determine whether the required verification is for ULS or SLS (in order to be able to call the appropriate generic equation, but also to proceed to different verifications). In order to achieve this, a binary value (0 or 1) is assigned to the CLC attributes, which can be described as follows:
CheckELU=1 if the CLC refers to a ULS verification; 0 else
CheckELS=1 if the CLC refers to a SLS verification; 0 else

The effective number of spans is compared to the condition on the minimum number of spans MinNbSpan in order to determine the value of a binary boolean ConsiderSpan taken as 1 if the effective number of spans is greater than MinNbSpan, taken as 0 else.

Both sets of data are combined together, and further combined to the condition of the minimum number of spans ConsiderSpan in order to determine the value of a binary boolean ConsiderSLC, which result states whether a given CLC shall be considered or not:

ConsiderCLC=ConsiderSpan*(CriticalG*IsG+CriticalQ*IsQ+CriticalS*IsS+CriticalW*IsW)

The CLC is considered in the design process when ConsiderCLC is non-null, the CLC is ignored when ConsiderCLC is null.

The advantage at this stage of the design system based on the invention is the obvious simplicity of the programming procedure for modifications and the flexibility for adding or modifying a CLC, a load type, a load configuration, without the need to enter in complex imbrications of conditional loops (if/then/else alike).

The entirety of the data necessary for the auto-determination of the CLC to be analysed can be gathered in the same database following the format identical with the one presented for the SLC.

However, the CLC database must be separate from the SLC database as, on the one hand the number of CLC is significantly larger than the number of SLC, and on the other hand this CLC database shall also contain all of the factors applying to the various coefficients of the generic equations.

It is reminded at this stage that the design system based on the invention utilises the principle of superposition and that subsequently, the loads are not combined to obtain the final design result by calling the solver after combination, but a limited number of single load cases (SLC) are calculated by calling the solver, which results are then combined when proceeding with the CLC to obtain the final result.

So to be able to combine the SLC results corresponding with each load instead of combining the loads themselves, the SLC results stored in the temporary storage table described previously (see Table No 3) are called. Each SLC has been assigned previously a unique identification number SLCNo in the SLC database, this identification number being reuses in the results storage table. This same unique number is used in a CLC for calling the appropriate SLC results.

For example, when the considered CLC combines the loads G+Q+S+W in the elementary load configuration “Alternate EVEN Spans” which ModelNb is 1, the SLC results of each type of load required for which ModelNb=1 will be combined. By reading from the SLC table presented previously this yields:
SLCNo=1 G on all spans (ModelNb=0) as G is always present on all spans
SLCNo=3 Q on EVEN spans (ModelNb=1)
SLCNo=10 S on EVEN spans (ModelNb=1)
SLCNo=17 Won EVEN spans (ModelNb=1)

TABLE No 6
Constitution of the CLC

| CLC | | Model | MinNb | Critical | Critical | Critical | Critical | | | | | |
|---|---|---|---|---|---|---|---|---|---|---|---|---|
| No | CLC | Nb | Span | G | Q | S | W | SLCNo_G | SLCNo_Q | SLCNo_S | SLCNo_W | . . . |
| 1 | G | 0 | 1 | 1 | 0 | 0 | 0 | 1 | — | — | — | . . . |
| 2 | G + Q | 0 | 1 | 1 | 1 | 0 | 0 | 1 | 2 | — | — | . . . |
| 3 | G + Q | 1 | 2 | 1 | 1 | 0 | 0 | 1 | 3 | — | — | . . . |
| 4 | G + Q | 2 | 2 | 1 | 1 | 0 | 0 | 1 | 4 | — | — | . . . |
| 5 | G + Q | 3 | 3 | 1 | 1 | 0 | 0 | 1 | 5 | — | — | . . . |
| 6 | G + Q | 4 | 3 | 1 | 1 | 0 | 0 | 1 | 6 | — | — | . . . |
| 7 | G + Q | 5 | 3 | 1 | 1 | 0 | 0 | 1 | 7 | — | — | . . . |
| 8 | G + Q | 6 | 3 | 1 | 1 | 0 | 0 | 1 | 8 | — | — | . . . |
| 9 | G + S | 0 | 1 | 1 | 0 | 1 | 0 | 1 | — | 9 | — | . . . |
| 10 | G + S | 1 | 2 | 1 | 0 | 1 | 0 | 1 | — | 10 | — | . . . |
| 11 | G + S | 2 | 2 | 1 | 0 | 1 | 0 | 1 | — | 11 | — | . . . |
| 12 | G + S | 3 | 3 | 1 | 0 | 1 | 0 | 1 | — | 12 | — | . . . |
| 13 | G + S | 4 | 3 | 1 | 0 | 1 | 0 | 1 | — | 13 | — | . . . |
| 14 | G + S | 5 | 3 | 1 | 0 | 1 | 0 | 1 | — | 14 | — | . . . |
| 15 | G + S | 6 | 3 | 1 | 0 | 1 | 0 | 1 | — | 15 | — | . . . |
| . . . | . . . | . . . | . . . | . . . | . . . | . . . | . . . | . . . | . . . | . . . | . . . | . . . |
| 23 | G + Q + W | 0 | 1 | 1 | 1 | 0 | 1 | 1 | 2 | — | 16 | . . . |
| 24 | G + Q + W | 1 | 2 | 1 | 1 | 0 | 1 | 1 | 3 | — | 17 | . . .. |
| 25 | G + Q + W | 2 | 2 | 1 | 1 | 0 | 1 | 1 | 4 | — | 18 | . . . |
| 26 | G + Q + W | 3 | 3 | 1 | 1 | 0 | 1 | 1 | 5 | — | 19 | . . . |
| 27 | G + Q + W | 4 | 3 | 1 | 1 | 0 | 1 | 1 | 6 | — | 20 | . . . |
| 28 | G + Q + W | 5 | 3 | 1 | 1 | 0 | 1 | 1 | 7 | — | 21 | . . . |
| 29 | G + Q + W | 6 | 3 | 1 | 1 | 0 | 1 | 1 | 8 | — | 22 | . . . |
| . . . | . . . | . . . | . . . | . . . | . . . | . . . | . . . | . . . | . . . | . . . | . . . | . . . |
| N | G + Q + S + W | 0 | 1 | 1 | 1 | 1 | 1 | 1 | 2 | 9 | 16 | . . . |
| N + 1 | G + Q + S + W | 1 | 2 | 1 | 1 | 1 | 1 | 1 | 3 | 10 | 17 | . . . |
| N + 2 | G + Q + S + W | 2 | 2 | 1 | 1 | 1 | 1 | 1 | 4 | 11 | 18 | . . . |
| N + 3 | G + Q + S + W | 3 | 3 | 1 | 1 | 1 | 1 | 1 | 5 | 12 | 19 | . . . |
| N + 4 | G + Q + S + W | 4 | 3 | 1 | 1 | 1 | 1 | 1 | 6 | 13 | 20 | . . . |
| N + 5 | G + Q + S + W | 5 | 3 | 1 | 1 | 1 | 1 | 1 | 7 | 14 | 21 | . . . |
| N + 6 | G + Q + S + W | 6 | 3 | 1 | 1 | 1 | 1 | 1 | 8 | 15 | 22 | . . . |

Hence, the CLC database specifies for each load type existing in the design system (which number is finite) the SLC number to call for each CLC contained in the database. Table No 6 presents an extract illustrating this principle.

In order to calculate the CLC by combination of the SLC results, the generic equation for the load combination [CLC] for ULS is recalled:

ULS_[CLC]=ULS_{—}G*G+Σ₍ᵢ₌₁₋ᵢ₎{ULS_[loadi]*[loadi]}

For the j variables loads [loadi] present on the beam member being designed, where:

ULS_{—}G=K_{—}GAdĵK_{—}GAdjFactor*K_{—}ĜK_{—}GFactor*K_{—}GUp̂K_{—}GUpFactor and:

ULS_[load]=Consider[load]Factor*Π₍ₙ₌₁₋ᵢ₎{C_[load]n̂C_[load]nFactor*K_[load]n̂K_[load]nFactor}

The generic equation for the load combination [CLC] for SLS is recalled:

Utot_[CLC]=Ufin_{—}G+Σ_{(i=1*j)}{Ufin_[loadi]}

For the j variables loads [loadi] present on the beam member being designed, where:

Ufin_{—}G=Uinst_{—}G*(InstantFactor_{—}G+CreepFactor_{—}G*C_Creep) and:

Ufin_[load]=Uinst_[load]*(Consider[load]_{Factor}+Σ₍ₙ₌₁₋ᵢ₎{(InstantFactor_[load]n*C_[load]n}+CreepConsider_[load]*C_[load]3̂CreepFactor_[load]3*C_Creep)

Defining: Uinst_{—}GFactor=(InstantFactor_{—}G+CreepFactor_{—}G*C_Creep)

and: Uinst_[load]Factor=(Consider[load]Factor+Σ₍ₙ₌₁₋ᵢ₎{InstantFactor_[load]n*C_[load]n}+CreepConsider_[load]*C_[load]3̂CreepFactor_[load]3*C_Creep)

Then rearranging: Ufin_{—}G=Uinst_{—}G*Uinst_{—}GFactor

Ufin_[load]=Uinst_[load]*Uinst_[load]Factor

Therefore: Uₜₒₜ_{_{—}}_{[CLC]}=Uᵢₙₛₜ_{_{—}}_{GFactor}*Uᵢₙₛₜ_{_{—}}_{G}+Σ₍ₗ₌₁₋ᵢ₎{Uᵢₙₛₜ_{_{—}}_{[loadi]Factor}*Uᵢₙₛₜ_{_{—}}_{[loadi}]}

It is reminded that the format for storage of SLC results is presented in Table No 3.

The design system based on the invention, when calculating a CLC, does not call in its generic equation the load itself, but the relevant result of the corresponding SLC. The elements of the generic equations can therefore be put in relationship with those of the SLC results storage table as follows:
for ULS:
   G refers to R_{1,i} or M_{1,i} or V_{1,i} where i is the index of the model node
   [loadj] refers to R_{N,i} or M_{N,i} or V_{N,i} where N is the SLC number corresponding to one of the configurations of the load [loadj], and i is the index of the model node
      depending on whether R, M or V is verified
for SLS:
   Uᵢₙₛₜ_{_{—}}_{G} refers to D_{1,j} where i is the index of the model node
   Uᵢₙₛₜ_{_{—}}_{[loadi]} refers to D_{N,i} where N is the SLC number corresponding to one of the configurations of the load [loadj], and i is the index of the model node

When noting X_{N,i} the result of SLC No N recorded at the node No i for the verification of X (which can be R, M, V or D), the generic equations can be rewritten at each node No i as follows:

### for ULS:

ULS_[CLC]i=ULS_{—}G*X_{1,i}+Σ₍ᵢ₌₁₋ₖ₎{ULS_[loadj]*X_{N,i}}

### and for SLS:

Utot_[CLC]i=Uinst_{—}GFactor*X_{1,i}+Σ₍ᵢ₌₁₋ₖ₎{Uinst_[loadj]Factor*X_{N,i}}

Finally, when proceeding to a verification following a design standard, it is sought to determine the maximum total acting stress (combined and factored) or the maximum total final deflection (combined) along the whole member. It is not possible to predetermine the node at which the maximum will be found. Furthermore, the maximum for a given SLC can be located at a different node than that of the maximum of another SLC, and the factored and combined value of both can see its maximum occurring at a third node different from both previous ones.

It is therefore necessary to factor and combine the SLC to obtain CLC results at each node prior to determining in a second step the maximum of all CLC results at the nodes:

### for ULS:

$$\begin{matrix}ULS\_ [ CLC ] max = {Max}_{( i = 1 - m )} [ ULS\_ [ CLC ] i ] \\ = {Max}_{( i = 1 - m )} [ \begin{matrix}ULS\_G * {X}_{1 , i} + \\ {\sum }_{( j = 1 - k )} \{ ULS\_ [ load j ] * {X}_{N , i} \}\end{matrix} ]\end{matrix}$$

### and for SLS:

$$\begin{matrix}Utot\_ [ CLC ] max = {Max}_{( i = 1 - m )} [ Utot\_ [ CLC ] i ] \\ = {Max}_{( i = 1 - m )} [ \begin{matrix}Uinst\_GFactor * {X}_{1 , i} + \\ {\sum }_{( j = 1 - k )} \{ Uinst\_ [ load j ] Factor * {X}_{N , i} \}\end{matrix} ]\end{matrix}$$

This way the maximum total acting stress (combined and factored) or the maximum total final deflection (combined) along the whole member is determined for the given CLC, which shall now be considered along with the DOL class determined fort the CLC in order to proceed to the final stage of the verification, i.e. to compare this maximum to the control value (or limiting allowable value).

When proceeding to such verification following a design standard (structural analysis) the control value represents either:
an allowable (or maximum or design) resistance when verifying the ULS, or
a maximum allowable deflection when verifying the SLS.

The maximum allowable deflection is typically defined as a fraction of the beam span (e.g. L/250, i.e. 1/250^{th} of the span) or as an absolute maximum (e.g. 12 mm).

The design system based on the invention facilitates the management of the control values of the resistances from several design standards, showing significant differences.

The control value X_{d} of the resistance to a solicitation noted X is typically obtained by means of three terms of different origins:

X_{d}=K_{X,adj}*K_{X,mat}*Xₖ where:
Xd is the control value of the resistance of the beam to the solicitation X
Xk is the reference resistance (characteristic or allowable) of the beam to the solicitation X
K_{X,mat} is an adjustment factor of the resistance depending on the material, the standard, the DOL class, moisture content, or any other factor influencing the resistance of the material itself—this factor can be considered a safety factor
K_{X,adj} is an adjustment factor of the resistance directly related to requirements stipulated by the design standard used for the verification of the relevant solicitation, typically independent from the material itself

The reference resistance Xₖ, defined for each design standard is obtained:
either by direct reading of mechanical properties of the beam in an ad hoc database,
or by a preliminary calculation based on the dimensions of the beam and the mechanical properties of the material it is made from.

In both cases, the reference mechanical properties are stipulated in each country, for each design standard, either in product standards or in specific product approvals or certificates.

These reference mechanical properties are of a finite number and known from the man of the art, their organisation in a database is therefore trivial with respect to the design system based on the invention.

The adjustment factor K_{X,adj} is directly dependent from the calculation rules defined in the design standard used for each of the solicitations. It can be simply equal to 1, or be the result of the product of several adjustments.

The design system based on the invention defines this term as:
either the product of each of the adjustment factors of the resistance X for each standard Y, when different from 1, the respective values are then contained in an ad hoc database,
or as a unique factor which value specific to each standard Y is held in an ad hoc database.

The choice between both options is done on a case-by-case basis following the requirements of the design standards considered. This choice does not really matter, recognising that it is obviously extremely easy to add an additional factor in the equation, as it is only required to add:
a new field in the corresponding database, which value will be 1 for all considered design standards except the one requiring this new factor;
the variable in the equation itself, which calls out the new field created in the database;
when necessary the corresponding output message in the design report indicating that this factor has been taken into account.

The adjustment factor K_{X,mat} is the most complex to manage, and is one of the elements which makes it very complex to manage simultaneously several design standards within the same design module.

The design system based on the invention considers a minimum of 4 different factors which are combined to form K_{X,mat}:
K_{DOL+MC} adjustment factor function of the DOL class and moisture content=e.g. 15 different values are required corresponding to the 5 <<system>> DOL classes and the 3 MC classes
K_{Norm} normalisation factor of the reference resistance=this coefficient is differentiated for each solicitation hence e.g for 4 values (M, V, R and D)
K_{SyS} adjustment factor of the resistance taking benefit from system effect (repetitive members)=this coefficient is differentiated for each solicitation hence e.g for 3 values (M, V, R)
K_{Mat} at adjustment factor of the material (safety)=this factor is typically differentiated by material or product, it may however happen that different values are to be applied to different verification such as M, V or R, e.g. 3 values are therefore considered.

Therefore, in our example, 25 adjustment factors of the material properties are necessary to be able to call the appropriate value for the relevant solicitation being verified, the DOL class, the MC conditions, and to combine these values using the equation:

K_{X,mat}=K_{sys}*K_{DOL+MC}*K_{Norm}/K_{Mat}

The entirety of the adjustment factor is contained in an ad hoc database and differentiated for each of the materials or products requiring different treatment (set of factors) and for each design standard. Each material or product shall therefore be present for each design standard and its data input.

Once the control value determined as such, it just needs to be compared to the corresponding CLC result to verify whether the member satisfies or not to the loading conditions and the requirements of the design standard used.

In the section thereafter, an example will illustrate how the design system based on the invention enables to reduce drastically the number of calls to the matrix solver, a time consuming task in the design process.

The case considered is that of a wood based beam on 4 bearings (3 spans) subject to the loads G, Q, S, W as described previously, as well as to the following additional loads:
R Roof live load transferred to this beam
Wup Wind Uplift load transferred to this beam
SAd Accidental Snow load transferred to this beam
AdE Accidental action induced by an earthquake

The design conditions required by the Eurocodes are considered, namely:
EN 1990 Eurocode 0 for load combinations
EN 1991-1-1 Eurocode 1 part 1-1 for permanent and imposed (live) loads
EN 1991-1-3 Eurocode 1 part 1-3 for snow and accidental snow loads
EN 1991-1-4 Eurocode 1 part 1-4 for wind and wind uplift loads
EN 1995-1-1 Eurocode 5 part 1-1 for the general rules of design of a timber structure or building

Following the principle of mobility of variable loads and in order to determine the most unfavourable configuration of variable (non permanent) loads, for each of the load combinations listed thereafter, each of the load configurations of a given list shall be evaluated separately (see Table No 1).

Following the requirements of Eurocodes, the load combinations indicated in Table No 7 shall be considered (for clarity, when 2 or more variable actions are considered simultaneously, each variable action shall be in turn considered leading or companion action, hence the indicated permutations).

TABLE No 7
Load combinations

| Basic | | SLS | | Basic | | SLS | | Accidental | | SLS | SLS |
|---|---|---|---|---|---|---|---|---|---|---|---|
| Combinations | ULS | 1&2 | SLS 3 | Combinations | ULS | 1&2 | SLS 3 | Combinations | ULS | 1&2 | 3 |

| | | | | | | | | | |
|---|---|---|---|---|---|---|---|---|---|
| G only | X | X | | G + Q + W | X | X | X | G + SAd | X |
| G + Q | X | X | X | G + W + Q | X | X | X | G + SAd + Q | X |
| G + R | X | X | X | G + R + S | X | X | X | G + SAd + W | X |
| G + S | X | X | X | G + S + R | X | | | G + SAd + Q + W | X |
| G + W | X | X | X | G + Q + W + S | X | | | G + SAd + W + Q | X |
| G + Wup | X | X | X | G + W + S + Q | X | X | X | G + AdE | X |
| G + Q + R | X | X | X | G + S + Q + W | X | X | X | G + AdE + Q | X |
| G + R + Q | X | X | X | | | | | G + AdE + R | X |
| G + Q + S | X | X | X | | | | | G + AdE + S | X |
| G + S + Q | X | X | X | | | | | G + AdE + Q + S | X |

SLS1 = Total long term deflection;
SLS2 = deflection supported by secondary works;
SLS3 = Instantaneous live load deflection

The calculations of SLS 1, 2 and 3 correspond to deflections that require distinct calls to the solver to be computed appropriately.

Therefore in this example there are:
7 different configurations (1 only applying to the load combination “G only” as dead load is by definition present on all spans)
26+1 (“G only”) different load combinations for ULS
14+1 (“G only”) different load combinations for SLS 1 & 2 (including “G only”)
14 different load combinations for SLS 3

Typical programming strategy consists in following linearly what would be a “manual” design, i.e. design (hence call the solver for) each of the load case separately.

In the present example, due to the necessity to factor loads for ULS calculations, and due to the differentiation of deflections, and despite the fact that a given load case is common to the 4 verifications ULS, SLS 1, SLS 2 and SLS 3, the solver must be called separately for each of them.

The number of calls to the solver is determined for this example as follows:
ULS 26 combinations*7 configurations+1 (“G only”)=183 ULS load cases
SLS 1 14 combinations*7 configurations+1 (“G only”)=99 SLS 1 load cases
SLS 2 14 combinations*7 configurations+1 (“G only”)=99 SLS 2 load cases
SLS 3 14 combinations*7 configurations=98 SLS 3 load cases
   hence a total of 479 calls to the solver.

The design system based on the invention consists in;
Identifying the loads present
Identifying the configurations required (which are independent from the loads present)
Design separately each SLC formed from one single load type (no combination) taken with its gross magnitude (no factoring) and in a given configuration

As the loads are not factored and the deflections neither combined nor differentiated at this stage, it is sufficient for a given SLC to call the solver only once to generate the result data required for the 4 verifications ULS, SLS 1, SLS 2 and SLS 3.

The SLC concerned are:
G only configuration 0 only
Gred only configuration 0 only (data necessary for SLS 2)
Q only configurations 0 to 6
R only configurations 0 to 6
S only configurations 0 to 6
W only configurations 0 to 6
Wup only configurations 0 to 6
SAd only configurations 0 to 6
AdE only configurations 0 to 6

The number of calls to the solver in this example is determined as follows:

G only and Gred only 2 loads*1 configuration=2 SLC

Q, R, S, W, Wup, SAd, AdE 7 loads*7 configurations=49 SLC

hence a total of 51 calls to the solver,

The design system based on the invention enables in this case to divide the number of calls to the solver by a factor 9.4.

In the section thereafter, an example will illustrate how the design system based on the invention enables to analyse more accurately the long term final deflection (with creep) of composite wood based members and to prevent therefore calculating by means of conservative simplifications, which induce a heavier structure. This example shows how the design system based on the invention helps obtaining lighter buildings or structures.

Following the principles of design of deflection per Eurocode 5 (EN 1995-1-1), among the SLS verifications, that of the long term deflection is typically the governing design criterion for wood based bending beam members.

Calculation of this deflection is based on the instantaneous (elastic) deflection under the applied loads to the beam, increased by the additional viscoelastic deflection induced by long term creep.

The instantaneous deflection is that determined using the theory of material resistance, hence that determined by the solvers of design software.

Creep is taken into account by means of a factor greater than 1 multiplier of the instantaneous deflection. This creep factor is dependent from the wood based material considered, as certain wood based materials are more susceptible to creep than others. Creep of wood based materials is also dependent from the conditions of temperature and relative humidity of the environment in which they are placed.

Generally speaking, the additional deflection due to creep underlies a long term application of the load, and considers therefore only the permanent or quasi-permanent portion of the applied loads.

The basic equation for calculation of total long-term deflection per Eurocode 5 (EN 1995-1-1) is:

U_{final}=Uᵢₙₛₜ+U_{creep} where:

Uᵢₙₛₜ is the instantaneous deflection under all of the applied loads
U_{creep} is the deflection due to creep under the permanent and quasi-permanent portion of the loads

The deflection due to creep is defined as:

U_{creep}=Uᵢₙₛₜ*ψ₂*k_{def} where:

ψ₂ is a coefficient ≦1 indicating the quasi-permanent portion of the load (permanent when equal to 1)
k_{def} is the creep factor of the wood based material considered

This yields:

For the dead load: U_{final,G}=U_{inst,G}*(1+k_{def})(ψ₂=1)

For the leading variable action: U_{final,Q1}=U_{inst,Q1}*(1+ψ_{2,1}*k_{def})

For the companion variable actions: U_{final,Qi}=U_{inst,Qi}(ψ_{0,i}+ψ_{2,i}*k_{def})

where ψ_{0,i} is the load combination factor when more than one variable load are considered.

This can be combined to form one single equation:

U_{final}=U_{inst,G}*(1+k_{def})+U_{inst,Q1}*(1+ψ_{2,i}*k_{def})+ΣU_{inst,Qi}*(ψ_{0,i}+ψ_{2,i}*k_{def})

This equation can be utilised directly in the case of a beam made from one single homogeneous wood based material, but requires more detailed analysis when considering a composite beam i.e. made from two wood based materials which behaviour relative to creep are different.

Furthermore it is already obvious, knowing that the factors ψ_{0,i} et ψ_{2,i} vary from one type of load to another, that it is not possible to calculate the total Uᵢₙₛₜ for the load combination G+Q₁+Σψ_{0,i}Qᵢ and to apply then a unique multiplying creep factor without requiring a simplification which will have to be conservative to not exceed the allowable limits.

Eurocode 5 requires to take into account the specificity of a beam made from materials having a different behaviour relative to creep, and proposes a simplification consisting in calculating an equivalent creep factor calculated from the creep factors of both components:

k_{def,equiv}=(k_{def,1}*k_{def,2})̂0.5

The design system based on the invention, through its two essential characteristics enables however a much more accurate approach detailed thereafter.

Typically composite wood based beams are of an I-shape or similar. On purpose, two different materials are used for the flanges (or chords) and the web in order to minimise the amount of material used by choosing materials based on their mechanical properties with respect to the stresses acting in the different components.

Typically flanges (or chords) are subject to flexural (bending) stresses, and tension/compression stresses induced by flexure, all nearly inexistent within the web. The web on the other hand is mainly subject to shear stresses nearly inexistent within the flanges.

Deflection of a bending beam member under a load comprises two components:
U_{inst,M} deflection induced by the flexural moment, which is dependent from the flexural rigidity (bending stiffness) of the beam, mainly related for a composite beam to the modulus of elasticity (or Young modulus) of the flange material;
U_{inst,V} deflection induced by vertical shear, which is dependent from the shear rigidity (shear stiffness) of the beam, mainly related for a composite beam to the shear modulus of the web material.

This can be summarised as:

Uᵢₙₛₜ=U_{inst,M}+U_{inst,V}

Hence for a composite beam, it will be sought to apply:
The creep factor k_{def,M} related to flanges, to the deflection induced by flexural moment U_{inst,M}
The creep factor k_{def,V} related to the web, to the deflection induced by vertical shear U_{inst,V}

When applying this principle to the different load types of the combination mentioned previously, a more complex but also more accurate equation is obtained.

The design system based on the invention enables thanks to the decomposition in SLC to determine the deflections of each load type separately, without factoring, and to evaluate for each of them both components of the deflection separately. The combination of the results using the appropriate factoring associated to the automated management of load combination coefficient and creep factors facilitate this accurate calculation.

So to compare the simplified approach of Eurocode 5 with the more accurate approach made possible by the design system based on the invention, a relative calculation will be conducted thereafter using a common set of assumptions.

The composite wood based beam (proposed by two large European manufacturers) considered is made from:
solid timber (lumber) flanges which creep factor is:
   k_{def,M}=0.60 in service class 1 (Interior heated climate)
   k_{def,M}=0.80 in service class 2 (protected from weathering, unheated climate)
a hardboard web which creep coefficient is:
   k_{def,M}=2.25 in service class 1 (interior heated climate)
   k_{def,M}=3.00 in service class 2 (protected from weathering, unheated climate)

In order to simplify the relative calculation the following assumptions are made, consistent with typical design situations encountered for floors in residential buildings:
the floor joist (beam) considered is subject to typical residential floor dead load and live load, and reaches approximately the maximum allowable span limit
the instantaneous deflection due to vertical shear represents approximately 20% of the total instantaneous deflection, hence:

U_{inst,V}=0.20*Uᵢₙₛₜ

U_{inst,M}=0.80*Uᵢₙₛₜ
The dead load G is approximately one half the residential floor live load Q (typically G=0.75 kN/m² and Q=1.50 kN/m²), hence: Q=2*G
The instantaneous deflections are considered unitary (for relative calculation) and such as:

U_{inst,G}=1.0

U_{inst,G}=2.0

It is reminded that deflection is directly proportional to the load.

$$\begin{matrix}{k}_{def , equiv} = ( {k}_{def , 1} * {k}_{def , 2} ) \hat{} 0.5 \\ = ( 0.60 * 2.25 ) \hat{} 0.5 \\ = 1.162 in service class 1 \\ = ( 0.80 * 3.00 ) \hat{} 0.5 \\ = 1.549 in service class 2\end{matrix}$$

Applying the simplified Eurocode 5 method yields:

$$\begin{matrix}Ufinal = 4.959 in service class 1 \\ = 5.478 in service class 2\end{matrix}$$

Applying the design system based on the invention yields:

$$\begin{matrix}Ufinal = 4.488 in service class 1 \\ = 4.984 in service class 2\end{matrix}$$

Comparison of both approaches shows a difference of:
10.5% in service class 1
9.9% in service class 2

The design system based on the invention enables to reduce (in the example presented) by about 10% the total long-term deflection, which translates for the beam considered into an increased spanning capacity (maximum allowable span). Alternatively this enables to utilise a lighter beam for an identical span. In both cases a globally lighter structure is obtained.

In the section thereafter, an example will illustrate how the design system based on the invention facilitates the transfer of unfactored loads from one element to another and prevents overloading due to successive factoring.

It is inescapable in structural analysis to have to transfer loads from one loadbearing member to another one supporting the former. In essence, it is the reaction of the supported member at its bearings which shall be transferred to the members supporting it. These reactions are determined during the design of the supported member, under the loads applied to it.

The transferred load is that corresponding with the highest magnitude of the reaction obtained during verification of the different load cases.

It is therefore easy for software to determine the maximum value from the combinations and permutations considered in design. The result however is a maximum factored and combined reaction.

When considering a beam over 2 bearings over a span L, subject to uniformly distributed load q_{tot,1} (see formula defined previously), the reaction obtained is:

R_{tot,1}=q_{tot,1}*L/2

Once transferred, this reaction will be factored and combined again. This cannot be done as such as it is not possible to distinguish the portion of R due to G (R_{G}) from that due to Q (R_{Q}), S (R_{S}) or W (R_{W}) and because R_{tot,1} is already a factored value. It is therefore necessary to determine these individual and unfactored portions. This could be done proportionally:

R_{G}=G/q_{tot,1}*R_{tot,1}

R_{Q}=Q/q_{tot,1}*R_{tot,1}

R_{S}=S/q_{tot,1}*R_{tot,1}

R_{W}=W/q_{tot,1}*R_{tot,1}

These portions can then be reapplied to the member supporting the corresponding beam, and they can be factored and combined within the scope of the verifications of this new member, preventing as such to factor them to the power 2.

This proportional determination requires the ability to establish the proportionality of each of the loads. In the aforementioned example of a uniformly distributed load, it is the case, the calculation is straightforward and it can be done upstream without the need for calling the solver.

In the analysis of frequently encountered more complex design cases, beams are subject to a combination of uniformly distributed loads and concentrated loads. It becomes then more difficult to determine the proportionality of these loads on the sole basis of their magnitudes and positions without calling the solver to determine the reactions and attempt then to deduct the proportions by difference.

This type of post-processing is quite complex to implement and automate in an efficient manner, even more because the combinations necessary for this deduction are not always available at that stage of the process: when one of the combinations is not required by the design standard it is usually not included in the program. Only option left is then to implement redundant factoring.

The decomposition in single load cases “SLC” per the design systems based on the invention allows intrinsically to determine for each type of load present on a member the maximum reaction at each bearing while isolating the type of loads without any factoring.

The maximum number of SLC is finite and known, which is not the case of the number of loads on a member, which can vary from 1 to more than 400 (see the example relative to the number of calls to the solver). Recording these results in a table being therefore predetermined is very simple and allows utilising them for a transfer to the subsequent members without any form of post-processing being required.

This way, redundant factoring is easily overcome, yielding a building structure more accurately designed and subsequently lighter than using the state of the art.

In the section thereafter, an example will illustrate how the design system based on the invention, through its flexibility, enables to manage very easily modifications or additions usually considered complex in the world of programming, often without modifying the source code through a simple update of one or two databases. To illustrate this flexibility, the (proved) case of the addition or modification of a design standard will be presented.

Each Eurocode, although being up to 99.5% common to all countries of the European Union, gives the member states the right and latitude to define a given number of so called nationally determined parameters (NDP) as well as to set complementary rules non-contradictory with the relevant Eurocode. These national specificities are contained in the National Annex to the relevant Eurocode and, unlike what may be expected, do handle fields of the standard that are economically critical.

Within this scope, Belgium has determined in its National Annex to EN 1995-1-1 (Eurocode 5) in paragraph 7.2(2) that the limiting values for deflection shall conform with the prescriptions of the Belgian standard NBN B03-003. The latter does not limit its scope to the definition of deflection limits for various types of buildings, but sets also the principle that the indicated limits do apply to deflections calculates using:
For instantaneous deflections: the frequent combination from EN 1990 (Eurocode 0)—equation (6.15b)
For creep deflection: the quasi-permanent combination from EN 1990—equation (6.16b)

This differs from the principle set in EN 1995-1-1, which indicates that deflection shall be calculated using:
For instantaneous deflections: the characteristic combination from EN 1990 (Eurocode 0)—equation (6.14b)
For creep deflection: the quasi-permanent combination from EN 1990—equation (6.16b)

This difference remains however valid and imposes itself to designers who want to design a wood based beam intended for the Belgian market. The equations following both methods will be compared thereafter to illustrate the difficulties related to the implementation of the requirements of the Belgian National Annex in the design module.

It is reminded that: U_{final}=Uᵢₙₛₜ+U_{creep}.

The total final deflection U_{final} is calculated per EN 1995-1-1 as follows:

The characteristic combination is used for Uᵢₙₛₜ (EN 1990—eq. 6.14b):

Uᵢₙₛₜ=U_{inst,G}+U_{inst,Q1}+Σψ_{0,i}*U_{inst,Qi}

The quasi-permanent combination is used for U_{creep} (EN 1990—eq. 6.16b):

U_{creep}=[U_{inst,G}+ψ_{2,i}*U_{inst,Q1}+Σψ_{2,i}*U_{inst,Qi}]*k_{def}

Combining both yields the general equation giving the total long term deflection per EN 1995-1-1:

U_{final}=U_{inst,G}*(1+k_{def})+U_{inst,Q1}*(1+ψ_{2,i}*k_{def})+ΣU_{inst,Qi}*(ψ_{0,i}+ψ_{2,i}*k_{def})

The total final deflection U_{final} is calculated per Belgian National Annex and NBN B03-003 as follows:

The frequent combination is used for Uᵢₙₛₜ (EN 1990—eq. 6.15b):

Uᵢₙₛₜ=U_{inst,G}+ψ_{1,i}*U_{inst,Q1}+Σψ_{2,i}*U_{inst,Qi}

The quasi-permanent combination is used for U_{creep} (EN 1990—eq. 6.16b):

U_{creep}=[U_{inst,G}+ψ_{2,i}*U_{inst,Q1}+Σψ_{2,i}*U_{inst,Qi}]*k_{def}

Combining both yields the general equation giving the total long term deflection per EN 1995-1-1:

U_{final}=U_{inst,G}*(1+k_{def})+U_{inst,Q1}*(ψ_{1,i}+ψ_{2,i}*k_{def})+ΣU_{inst,Qi}*(ψ_{2,i}+ψ_{2,i}*k_{def})

The partial coefficients ψ_{0,i}, ψ_{0,i} et ψ_{2,i} vary depending on the type of load to which they refer and vary also from one country to another (these are NDP from EN 1990), inducing an intrinsic complexity. Moreover it is important to note that:
For ULS per EN 1995-1-1, only the ψ_{0,i} partial coefficients are necessary; and
For SLS per EN 1995-1-1, only the ψ_{0,i} et ψ_{2,i} partial coefficients are necessary.

Subsequently, the implementation of the Belgian National Annex in a design module requires to consider not only different values of the coefficients ψ_{0,i} et ψ_{2,i}, but also to add a new series of ψ_{1,i} unrequired and unutilised until then, and which do vary depending on the type of load considered. It is also necessary to include new combinations of loads utilising these coefficients therefore following a different model than the existing ones.

These modifications require typically significant changes to the source codes of programs and are considered as a proven programming complexity.

The design system based on the invention enables to very easily solve these issues as follows:

The generic equation for load combinations for SLS is recalled:

Utot_[CLC]=Uinst_{—}GFactor*Uinst_{—}G+Σ₍ᵢ₌₁₋ⱼ₎{Uinst_[loadi]Factor*Uinst_[loadi]}

where: Uinst_{—}GFactor=(InstantFactor_{—}G+CreepFactor_{—}G*C_Creep)

and: Uinst_[load]Factor=(Consider[load]Factor+Σ₍ₙ₌₁₋₃₎{InstantFactor_[load]n*C_[load]n}+CreepConsider_[load]*C_[load]3̂CreepFactor_[load]3*C_Creep)

EN 1995-1-1 and the “new” Belgian National Annex are managed by first filling in the database of load combination coefficients as follows for the type of [load i]:
C_[loadi]1=ψ_{0,i}
C_[loadi]2=ψ_{1,i}
C_[loadi]3=ψ_{2,i}
C_creep=k_{def}

Next, the binary (0 or 1) values of the factors from the CLC database are input for each of the loads [load i] as indicated in Table No 8:

The addition of the Belgian National Annex does therefore not require any modification of the source code, but only an update of 2 databases. This principle is verified for numerous modifications or additions that must be done to various elements necessary for the design of the beam.

Expending on the example, the design system based on the invention enables easily if necessary to add a new coefficient or factor to a generic equation and to the corresponding database. This addition is considered a minor modification of the source code, everything else remaining managed by means of the databases.

TABLE NO 8
Binary Values for the loads

| | EN 1995-1-1 | Belgian National Annex |
|---|---|---|
| For G: | | |
| InstantFactor_G = | 1 | 1 |
| CreepFactor_G = | 1 | 1 |
| for Q1 (leading): | | |
| Consider[load]Factor = | 1 | 0 |
| InstantFactor_[load]1 = | 0 | 0 |
| InstantFactor_[load]2 = | 0 | 1 |
| InstantFactor_[load]3 = | 0 | 0 |
| CreepConsider_[load] = | 1 | 1 |
| CreepFactor_[load]3 = | 1 | 1 |
| For Qi (companion): | | |
| Consider[load]Factor = | 0 | 0 |
| InstantFactor_(load]1 = | 1 | 0 |
| InstantFactor_(load]2 = | 0 | 0 |
| InstantFactor_[load]3 = | 0 | 1 |
| CreepConsider_[load] = | 1 | 1 |
| CreepFactor_[load]3 = | 1 | 1 |

This illustrates through an example the possibility given by the invention to provide updates to the remote users by means of sending an email rather than a somehow long lasting download, the size of the database files being typically of about a megabyte, enabling users who do not have access to a continuous internet connexion to receive the email during a short temporary connection, e.g. in a restaurant, and to then proceed to the update through a straightforward copy/paste of the updated file, in a matter of seconds.

Although the invention has been described in relation to particular structures, it is in no way limited to these and numerous variations can be brought to it.

The combinations of the different realisations represented on the drawings or described above do not exit the scope of the invention.

### LIST OF TRANSLATIONS OF IMPORTANT TERMS

Systéme de conception design system
norme applicable applicable standard
contrainte stress
déformation deflection
valeur(s) de contr\check{o}le control value(s)
combinaison(s) de charges load combination(s)
configuration de charges load configuration(s)
cas de charges load case(s)
cas de charge simples single load case
non pondérée unfactored
combinaisons normalisées de ces charges normalised combination of these loads

1-10. (canceled)

11. Design system for the structural design of a structure or building which shall be designed following an applicable standard defining the load combinations and the control values, the said structure or building being constituted of loadbearing members and subject to loads, the load combinations defined in the said applicable standard and applied to the said loadbearing members with the substantially most unfavourable load configuration being intended to induce maximum values of stresses and/or deflections in the said loadbearing members not exceeding the control values defined in the said standard, wherein the said design system comprises a database intended to store the numerical values corresponding to parameters related to the act of design, the said parameters taking different numerical values depending on the structure, the building, the materials, the usage, the geographical localisation or the applicable standard.

12. Design system according to claim 11, wherein the said parameters are the parameters of elaboration of the list of the said load combinations and of all of the said control values.

13. Design system according to claim 11, comprising a finite list of load configurations verifying the property that any configuration susceptible to occur in a structure or building will be sufficiently verified in terms of design if verifications are limited to the load configurations of the said list, and a list of single load cases for each loadbearing member obtained by combining each of the loads applied individually and unfactored to the said loadbearing member with each of the configurations of the said finite list, in which the said parameters are parameters of elaboration of the said list of single load cases.

14. Design system according to claim 12, comprising a finite list of load configurations verifying the property that any configuration susceptible to occur in a structure or building will be sufficiently verified in terms of design if verifications are limited to the load configurations of the said list, and a list of single load cases for each loadbearing member obtained by combining each of the loads applied individually and unfactored to the said loadbearing member with each of the configurations of the said finite list, in which the said parameters are parameters of elaboration of the said list of single load cases.

15. Design system according to claim 11, wherein the said structure or building is substantially in wood or metal or composite material.

16. Design system according to claim 11, wherein the said loadbearing members are substantially beam members or plate or shell members.

17. Design method for the design of a structure or building which shall be designed following an applicable standard defining the load combinations and the control values, the said structure or building being constituted of loadbearing members subject to loads, the load combinations defined in the said applicable standard and applied to the said loadbearing members with the substantially most unfavourable load configuration being intended to induce maximum values of stresses and/or deflections in the said loadbearing members not exceeding the control values defined in the said standard, comprising at least one of the following stages:
establishment of a list of single load cases to consider for each loadbearing member by means of parameterised formulas in which parameters are replaced by numerical values stored in databases, the said list being defined by application of each of the loads applied to the loadbearing member taken individually and unfactored to a predetermined list of load configurations,
calculation of combinations of stresses and/or deflections resulting from structural design of single load cases, and of control values, by means of parameterised formulas in which parameters are replaced by numerical values stored in databases, the said numerical values varying depending on the applicable standards.

18. Method according to claim 17, comprising the two said steps.

19. Utilisation of a design system according to claim 11, wherein updates of the system, especially following the modification of a standard or due to the addition of a new material, are overwhelmingly realised exclusively through replacement or addition of a database file, without modification of lines of the programs source code, such that the said updates can be realised using sufficiently small files able to be sent by electronic mail and/or the actual update process by the user can be processed in matter of seconds.
